(19) United States
(12) Patent Application Publication
(10) Pub. No.: US 2025/0187015 A1
(43) Pub. Date: Jun. 12, 2025

(54) SEGMENTED TRAYS FOR AUTOSAMPLER

(71) Applicant: DIONEX CORPORATION, Sunnyvale, CA (US)

(72) Inventors: Daniel Hoffmeyer, San Jose, CA (US); Husam AL-ESAWI, El Dorado Hills, CA (US)

(21) Appl. No.: 18/530,757

(22) Filed: Dec. 6, 2023

(51) Int. Cl. B01L 9/00; G01N 35/00; G01N 35/02

(52) U.S. Cl. CPC B01L 9/00; G01N 35/00732; G01N 35/04; B01L 2200/028; B01L 2300/021; B01L 2300/0609; G01N 2035/00742; G01N 2035/0422

(57) ABSTRACT

A segmented sample handling tray includes a plurality of sample handling segments, each sample handling segment includes a plurality of sample positions for sample containers; wherein the segmented sample handling tray transitions between a compact two-dimensional array configuration and an extended linear configuration by at least partially separating the plurality of sample handling segments.

### FIELD

The present invention relates to the field of analytical chemistry, particularly to autosamplers used in various laboratory settings. More specifically, this patent application aims to protect a novel sample handling design that enhances the efficiency and precision of sample introduction and analysis in analytical chemistry.

### BACKGROUND

Analytical chemistry plays a crucial role in numerous scientific disciplines, including pharmaceuticals, environmental monitoring, food and beverage analysis, and forensic sciences. One of the fundamental steps in analytical chemistry involves sample preparation and introduction into the analytical instrument, which traditionally relies on manual techniques. However, manual sample handling can be time-consuming, error-prone, and labor-intensive, often leading to reduced accuracy and reproducibility of analytical results.

To overcome these limitations, autosamplers have been developed to automate the sample introduction process, allowing for increased efficiency, precision, and throughput in analytical laboratories. Autosamplers are widely used in conjunction with various analytical instruments, such as gas chromatographs (GC), liquid chromatographs (LC), and mass spectrometers (MS), among others.

Conventional autosampler designs typically feature a sample tray or carousel that holds multiple samples, which are sequentially introduced into the analytical instrument. The automation of sample introduction eliminates the need for manual sample handling, reducing human error and increasing sample throughput. However, existing autosamplers may still face certain limitations that hinder their overall performance and efficiency.

### BRIEF SUMMARY

In a first aspect, a segmented sample handling tray can include a plurality of sample handling segments. Each sample handling segment can include a plurality of sample positions for sample containers. The segmented sample handling tray can transition between a compact two-dimensional array configuration and an extended linear configuration by at least partially separating the plurality of sample handling segments.

In various embodiments of the first aspect, the extended linear configuration can include the plurality of the sample handling segments being substantially end-to-end.

In various embodiments of the first aspect, the compact two-dimensional array configuration can include the plurality of the sample handling segments being substantially side-by-side.

In various embodiments of the first aspect, a lateral side of each of the plurality of sample handling segments can be at least partially open such that the sample containers are visible within the sample handling segments.

In various embodiments of the first aspect, the plurality of sample handling segments are coupled together using integral hinges. In particular embodiments, the integral hinges can be attached to the sample handling segments at an edge between an end and a lateral side of the sample handling segments. In particular embodiments, the integral hinges can be attached to the sample handling segments at an end of the sample handling segment.

In various embodiments of the first aspect, the plurality of sample handling segments can be coupled together using mechanical hinges.

In a second aspect, a sample handling system for use with a segmented sample handling tray including a plurality of sample handling segments can include a loading area for holding a segmented sample handling tray in a compact two-dimensional configuration; a conveyor for transporting the segmented sample handling tray in an extended linear configuration; a sample container read zone configured to identify the sample containers within the segmented sample handling tray; and a needle access zone for sampling the contents of the sample containers.

In various embodiments of the second aspect, the extended linear configuration can include the plurality of the sample handling segments being substantially end-to-end.

In various embodiments of the second aspect, the compact two-dimensional array configuration can include the plurality of the sample handling segments being substantially side-by-side.

In various embodiments of the second aspect, the sample container read zone can include a camera to read a label on the side of a sample container within one of the plurality of sample handling segments. A lateral side of each of the plurality of sample handling segments can be at least partially open so the label is visible to the camera.

In various embodiments of the second aspect, the sample container read zone can include an RFID reader to read an RFID tag on a sample container within one of the plurality of sample handling segments.

In various embodiments of the second aspect, the analytical system can further include a needle for accessing the contents of the sample container and providing the contents to an analytical system.

In particular embodiments, the analytical system can include a liquid chromatography system, an ion chromatography system, a gas chromatography system, a mass spectrometry system, a genetic analysis system, a gene sequencing system, an immunoassay system, or any combination thereof.

These and other objects and advantages shall be made apparent from the accompanying drawings and the description thereof.

### BRIEF DESCRIPTION OF THE FIGURES

The accompanying drawings, which are incorporated in and constitute a part of this specification, illustrate embodiments, and together with the general description given above, and the detailed description of the embodiments given below, serve to explain the principles of the present disclosure.

FIGS. 1A, 1B, and 1C illustrate an exemplary segmented sample handling tray for use with an autosampler, in accordance with various embodiments.

FIGS. 2A and 2B illustrate an exemplary integral hinge for use in a segmented sample handling tray, in accordance with various embodiments.

FIGS. 3A and 3B illustrate another exemplary integral hinge for use in a segmented sample handling tray, in accordance with various embodiments.

FIGS. 4A and 4B illustrate an exemplary mechanical hinge for use in a segmented sample handling tray, in accordance with various embodiments.

FIGS. 5A, 5B, and 5C illustrate an exemplary magnetic coupling for use in a segmented sample handling tray, in accordance with various embodiments.

FIG. 6 illustrates an exemplary autosampler for use with a segmented sample handling tray, in accordance with various embodiments.

FIG. 7 illustrates another exemplary autosampler for use with a segmented sample handling tray, in accordance with various embodiments.

FIG. 8 illustrates an exemplary sample identification mechanism for an autosampler for use with a segmented sample handling tray, in accordance with various embodiments.

### DETAILED DESCRIPTION

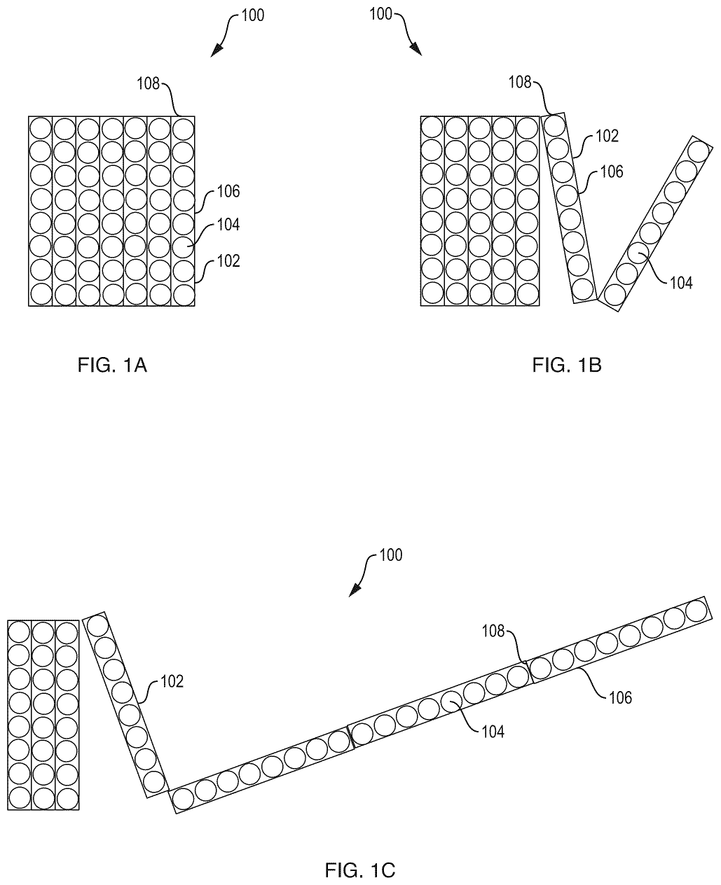

FIGS. 1A, 1B, and 1C illustrate a segmented sample handling tray 100 for use with an autosampler. The sample handling tray 100 includes a plurality of sample handling segments 102. Each sample handling segment 102 includes a plurality of sample positions 104 and is capable of holding a plurality of sample vials in a linear arrangement. In various embodiments, the sample handling segment 102 can include openings on a side that allow for the visual inspection of the sample vials, either directly by eye or by use of an optical system, such as a camera. Visual inspection of the sample vials from the side can be useful for reading labels, verifying the amount of sample in the vials, checking the quality of the sample in the vial, and the like. Checking the sample quality can include detecting indicators or a degraded sample, such as turbidity, the presence of precipitates, color changes, and the like.

The segmented sample handling tray 100 is capable of rearrangement between a two-dimensional array configuration (shown in FIG. 1A) to a linear configuration. FIGS. 1B and 1C illustrate the unfolding of the sample handling segments 102 to rearrange the segmented sample handling tray 100 into a partially linear configuration. In the compact two-dimensional array configuration shown in FIG. 1A, the lateral sides 106 of the sample handling segments 102 are adjacent. In the extended linear configuration, the ends 108 of the sample handling segments 102 are adjacent.

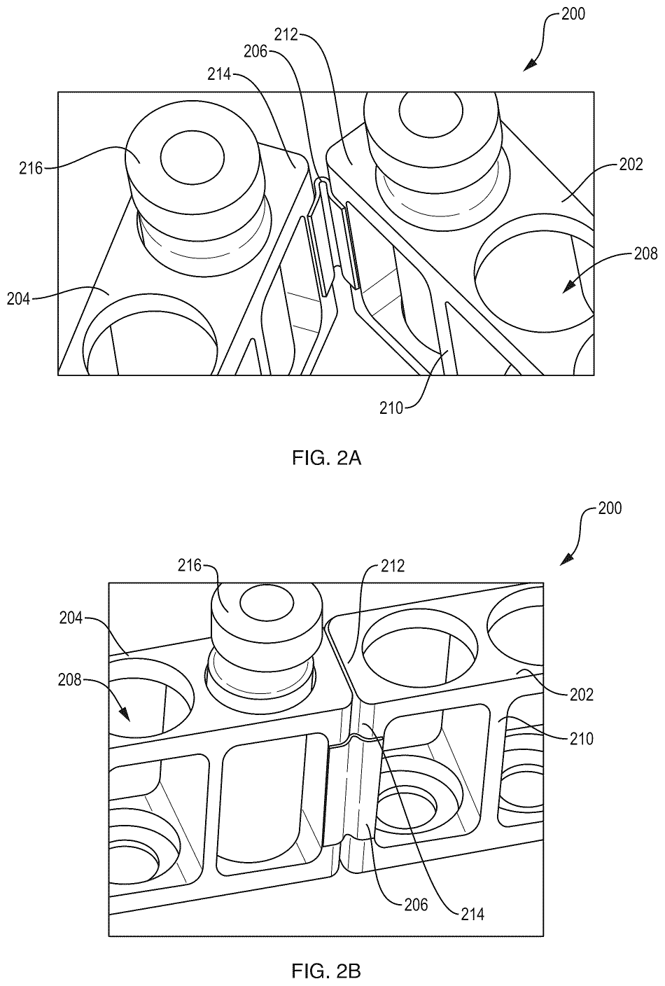

FIGS. 2A and 2B illustrate a portion of a sample handling tray 200 including sample handling segments 202 and 204 coupled with an integral hinge 206. Sample handling segments 202 and 204 each include a plurality of sample positions 208 for holding sample containers 216. Additionally, a lateral side 210 of the sample handling segments 202 and 204 can be at least partially open to allow viewing of the sample containers 216.

In various embodiments, the sample handling tray 200 can switch between a compact two-dimensional array configuration and an extended linear configuration. In the compact two-dimensional array configuration, the sample handling segments 202 and 204 can be arranged with the lateral sides 210 being adjacent. In the extended linear configuration, the sample handling segments 202 and 204 can be arranged with ends 212 being adjacent.

Integral hinge 206 can be connected to the sample handling segments 202 and 204 on the edge 212 of sample handling segments 202 and 204. In various embodiments, the sample handling segments 202 and 204 and the integral hinge 206 can be made of the same material, such as polypropylene, polyethylene or the like. In particular embodiments, the sample handling tray 200 can be formed by injection molding of the sample handling segments 202 and 204 and integral hinge 206 in a single injection mold.

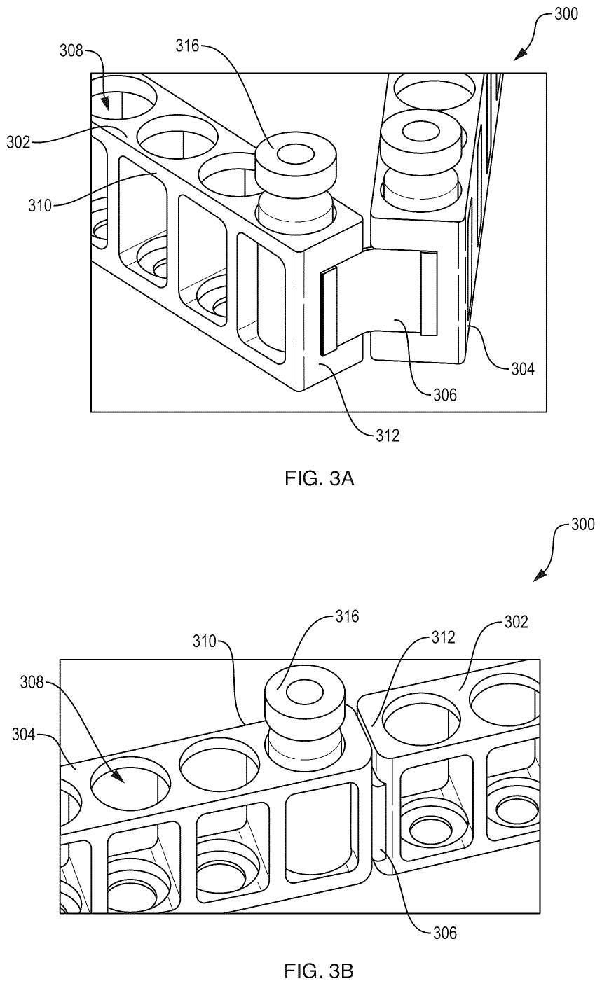

FIGS. 3A and 3B illustrate a portion of a sample handling tray 300 including sample handling segments 302 and 304 coupled with an integral hinge 306. Sample handling segments 302 and 304 each include a plurality of sample positions 308 for holding sample containers 316. Additionally, a lateral side 310 of the sample handling segments 302 and 304 can be at least partially open to allow viewing of the sample containers 316.

In various embodiments, the sample handling tray 300 can switch between a compact two-dimensional array configuration and an extended linear configuration. In the compact two-dimensional array configuration, the sample handling segments 302 and 304 can be arranged with the lateral sides 310 being adjacent. In the extended linear configuration, the sample handling segments 302 and 304 can be arranged with ends 312 being adjacent.

Integral hinge 306 can be connected to the sample handling segments 302 and 304 at the ends of sample handling segments 302 and 304. In various embodiments, the sample handling segments 302 and 304 and the integral hinge 306 can be made of the same material. The material can include a thermoplastic polymer, such as polypropylene, polyethylene, or the like. In particular embodiments, the sample handling tray 300 can be formed by injection molding of the sample handling segments 302 and 304 and integral hinge 306 in a single injection mold.

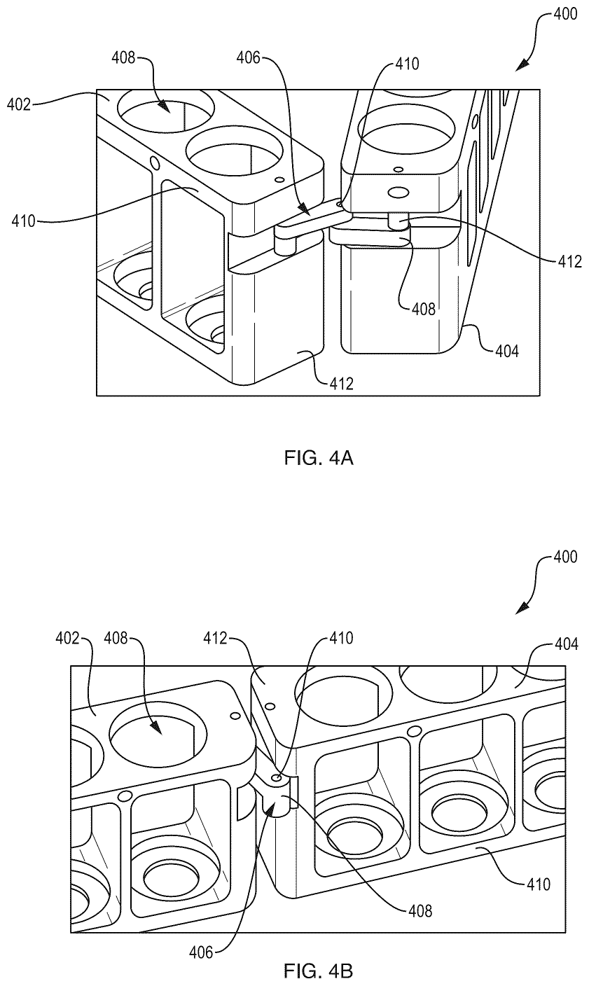

FIGS. 4A and 4B illustrate a portion of a sample handling tray 400 including sample handling segments 402 and 404 coupled with a mechanical hinge 406. Sample handling segments 402 and 404 each include a plurality of sample positions 408 for holding sample containers (not shown). Additionally, a lateral side 410 of the sample handling segments 402 and 404 can be at least partially open to allow viewing of the sample containers.

In various embodiments, the sample handling tray 400 can switch between a compact two-dimensional array configuration and an extended linear configuration. In the compact two-dimensional array configuration, the sample handling segments 402 and 404 can be arranged with the lateral sides 410 being adjacent. In the extended linear configuration, the sample handling segments 402 and 404 can be arranged with ends 412 being adjacent.

Mechanical hinge 406 can be connected to the sample handling segments 402 and 404. Mechanical hinge can include hinge elements 408 connected together via a pin 410 and coupled to the sample handling segments 402 and 404 with additional pins 412 at the ends of sample handling segments 402 and 404. In various embodiments, sample handling segments 402 and 404 can be made of a thermoplastic polymer, such as polypropylene, polyethylene, or the like, and injection molded as separate parts. The hinge elements 408 can be machined plastic parts and the sample handling tray 400 can be assembled by joining a plurality of sample handling segments with mechanical hinges.

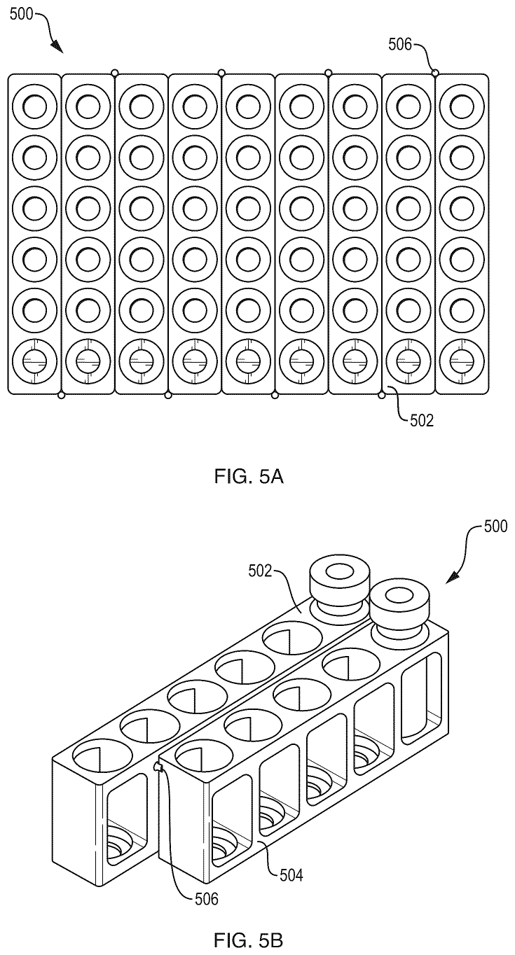

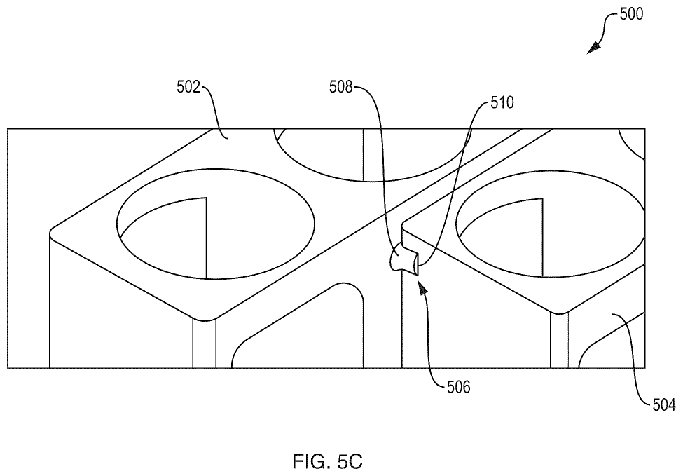

FIGS. 5A, 5B, and 5C illustrate a sample handling tray 500 including sample handling segments 502 and 504 coupled with detachable couplings 506. The detachable coupling 506 can include detachable coupling component 508 embedded in sample handling segment 502 and detachable coupling component 510 embedded in sample handling segment 504. In various embodiments, the detachable coupling 506 can be a magnetic coupling. When the detachable coupling 506 is a magnetic coupling, detachable coupling component 508 can be a permanent magnet with a first pole facing outward from the sample handling segments 502 and detachable coupling component 510 can be a permanent magnet with a first pole facing outward from the sample handling segments 504. The first pole can be a north pole of the magnet and the second pole can be a south pole of a magnet, or the first pole can be a south pole of a magnet and the second pole can be a north pole of a magnet. In another embodiment where the detachable coupling 506 is a magnetic coupling, detachable coupling component 508 can be a permanent magnet and detachable coupling component 510 can be a magnetically attracted material, such a ferromagnetic material or a paramagnetic material. Alternatively, detachable coupling components 508 and 510 can be switched, such that detachable coupling component 510 is a permanent magnet and detachable coupling component 508 is a magnetically attracted material.

The arrangement and location of detachable coupling components can ensure that the sample handling segments are arranged in particular orientations relative one another. For example, placement of the detachable couplings 506 in an asymmetric manner can substantially prevent orienting one of the sample handling segments 502 in a reversed orientation. Similarly, if detachable coupling components 508 and 510 are magnets, the orientation of the magnets can be used to substantially prevent a reverse orientation of one of the sample handling segments 502.

In various embodiments, detachable couplings can be used to configure a sample handling tray 500 with any number of sample handling segments 502, as well as sample handling segments of different sizes, such as sample handling segments 502 and 504, as shown in FIGS. 5B and 5C. In various embodiments, sample handling segments 502 and 504 can be made of a thermoplastic polymer, such as polypropylene, polyethylene, or the like, and injection molded as separate parts with the detachable coupling component embedded in the injection molded material.

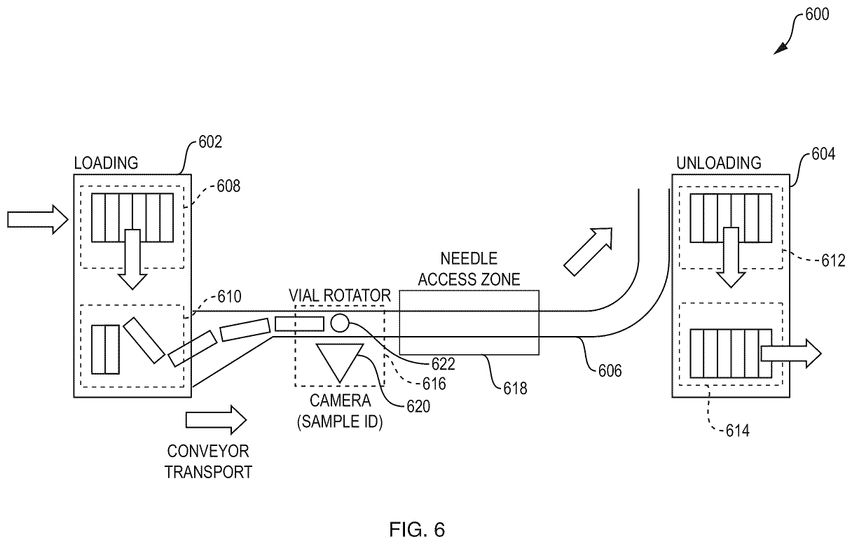

FIG. 6 illustrates an autosampler 600 for use with a segmented sample handling tray, such as sample handling trays 200, 300, 400, or 500. Autosampler 600 includes a loading area 602, an unloading area 604, a conveyor 606 to move the sample handling trays in a linear configuration between the loading area 602 and the unloading area 604.

Loading area 602 can include a waiting zone 608 where segmented sample handling trays are queued for use and a loading zone 610 where a segmented sample handling tray is fed to the conveyor 606. In various embodiments, loading area 602 can be in a vertical orientation where the segmented sample handling trays are stacked one atop another and segmented sample handling trays are lowered from the waiting zone 608 to the loading zone 610 when feeding of the previous sample handling tray is complete. In other embodiments, the loading area 602 can be in a horizontal orientation where the segmented sample handling trays are positioned adjacent one another and segmented sample handling trays are translated from the waiting zone 608 to the loading zone 610 when feeding of the previous sample handling tray is complete.

Unloading area 604 can include an unloading zone 612 where a segmented sample handling tray is recovered from the conveyor 606 and a waiting zone 614 where segmented sample handling trays are stored for removal. In various embodiments, unloading area 604 can be in a vertical orientation where the segmented sample handling trays are stacked one atop another and segmented sample handling trays are lowered from the unloading zone 612 to the waiting zone 614 when feeding of sample handling tray from the conveyor 606 is complete. In other embodiments, unloading area 604 can be in a horizontal orientation where the segmented sample handling trays are positioned adjacent one another and segmented sample handling trays are translated from the unloading zone 612 to the waiting zone 614 when feeding of sample handling tray from the conveyor 606 is complete.

Conveyor 606 can include a sample container read zone 616 and a needle access zone 618. The sample container read zone 616 can include a sample identification system 620, such as a camera, and a sample container rotator 622 to rotate the sample container. In various embodiments, the sample container rotator 622 can rotate the sample container within the sample handling segment to allow the sample identification system to access any part of the side of the sample container is necessary to identify the sample. In various embodiments, this can include rotating the sample container 360° to allow for reading a label that covers almost all of the side surface. In other embodiments, the sample container can be rotate to present a correct view of the sample container to the sample identification system. For example, a bar code or QR code on one portion of the label can be rotated to be in view of the sample identification system 620.

In other embodiments, the sample identification system can be a RFID reader and can read an RFID tag embedded in the sample container or lid or as part of a label. When using an RFID reader for identification, it may not be necessary to rotate the sample container within the sample handling segment.

In various embodiments, the needle access zone 618 can include a mechanism for accessing the sample within the sample container, generally by inserting a needle through a septum of the sample container to access the sample within. In various embodiments, the needle can draw up a liquid sample or sample gases in a head space above a sample. The portion of the sample withdrawn from the container can be analyzed using various analytical techniques, including but not limited to liquid chromatography, ion chromatography, gas chromatography, mass spectrometry, genetic analysis, gene sequencing, immunoassay, and the like, or any combination thereof.

One advantage of the segmented sample handling tray is that the side of the sample container can be viewable without removing the sample container from the segmented sample handling trays. In a traditional sample handling tray, viewing the side of a sample container from the interior of the sample handling tray would require lifting the sample container at least partially out of the sample handling tray so it can be viewed.

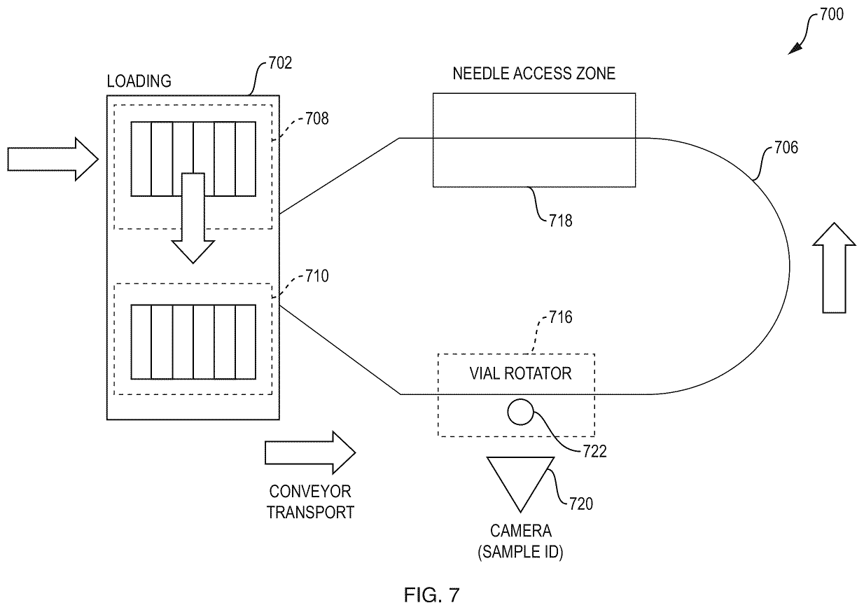

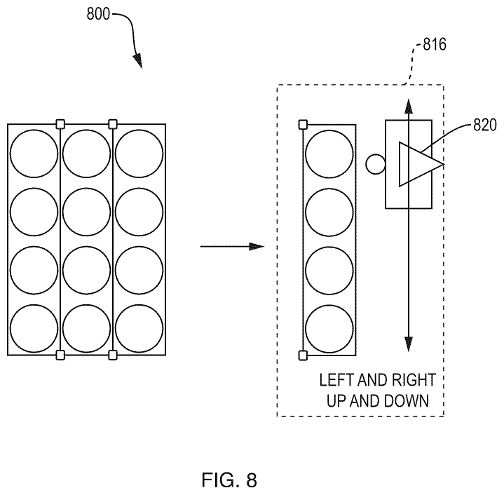

FIG. 7 illustrates an autosampler 700 for use with a segmented sample handling tray, such as sample handling trays 200, 300, 400, or 500. Autosampler 700 includes a storage area 702 and a conveyor 706 to move the linearized segmented sample handling trays in a loop from the storage area 702 through a sample container read zone 716, a needle access zone 718, and back to the storage area 702.

Storage area 702 can include a waiting zone 708 where segmented sample handling trays are queued for use and a loading zone 710 where a segmented sample handling tray is fed to the conveyor 706, transitioning from the compact two-dimensional array configuration to the linear configuration. In various embodiments, storage area 702 can be in a vertical orientation where the segmented sample handling trays are stacked one atop another and segmented sample handling trays are lowered from the waiting zone 708 to the loading zone 710 when feeding of the previous sample handling tray is complete. In other embodiments, the storage area 702 can be in a horizontal orientation where the segmented sample handling trays are positioned adjacent one another and segmented sample handling trays are translated from the waiting zone 708 to the loading zone 710 when feeding of the previous sample handling tray is complete.

Conveyor 706 can include a sample container read zone 716 and a needle access zone 718. The sample container read zone 716 can include a sample identification system 720, such as a camera, and a sample container rotator 722 to rotate the sample container. In various embodiments, the sample container rotator 722 can rotate the sample container within the sample handling segment to allow the sample identification system to access any part of the side of the sample container is necessary to identify the sample. In various embodiments, this can include rotating the sample container 360° to allow for reading a label that covers almost all of the side surface. In other embodiments, the sample container can be rotate to present a correct view of the sample container to the sample identification system. For example, a bar code or QR code on one portion of the label can be rotated to be in view of the sample identification system 720.

In various embodiments, processing of a segmented sample handling tray can include unpacking of the segmented sample handling tray into a linear configuration, identification of the sample containers in the sample container read zone 716, accessing the samples in the needle access zone 718, and repacking the segmented sample handling tray into a compact two-dimensional array configuration. In various embodiments, the autosampler can complete processing of a first segmented sample handling tray before advancing to a second segmented sample handling tray. In other embodiments, the loop may be large enough to accommodate two or more segmented sample handling trays in the extended linear configuration such that the autosampler can begin to unpack the second sample handling tray before the first sample handling tray is repacked. For example, the first sample handling tray can be unpacked and the samples can be identified. Then, while the first sample handling tray is moving through the needle access zone, the second sample handling tray can be unpacked and the sample can be identified. Once the second sample handling tray is unpacked, the first sample handling tray can be repacked before a third sample handling tray is moved to the loading zone 710.

In other embodiments, the sample identification system can be a RFID reader and can read an RFID tag embedded in the sample container or lid or as part of a label. When using an RFID reader for identification, it may not be necessary to rotate the sample container within the sample handling segment.

One advantage of the segmented sample handling tray is that the side of the sample container can be viewable without removing the sample container from the segmented sample handling trays. In a traditional sample handling tray, viewing the side of a sample container from the interior of the sample handling tray would require lifting the sample container at least partially out of the sample handling tray so it can be viewed.

In various embodiments, the needle access zone 718 can include a mechanism for accessing the sample within the sample container, generally by inserting a needle through a septum of the sample container to access the sample within. In various embodiments, the needle can draw up a liquid sample or sample gases in a head space above a sample. The portion of the sample withdrawn from the container can be analyzed using various analytical techniques, including but not limited to liquid chromatography, ion chromatography, gas chromatography, mass spectrometry, genetic analysis, gene sequencing, and the like, or any combination thereof.

FIG. 8 illustrates another sample identification system 800 for reading the sample containers, such as when using the detachable sample handling segments of segmented sample handling tray 500. Each detachable sample handling segment can be detached from the segmented sample handling tray and translated to the sample container read zone 816. The sample identification system 820 can be scanned across the detachable sample handling segment while the detachable sample handling segment remains static. Once the samples have been identified, the detachable sample handling segment can advance, and another detachable sample handling segment can enter the sample container read zone 816. This sample container reading mechanism can be incorporated into various autosamplers, such as autosampler 600 and autosampler 700.

In the present disclosure the singular forms “a”, “an” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

The modifier “about” should be considered as disclosing the range defined by the absolute values of the two endpoints. For example, the expression “from about 2 to about 4” also discloses the range “from 2 to 4.” When used to modify a single number, the term “about” may refer to plus or minus 10% of the indicated number and includes the indicated number. For example, “about 10%” may indicate a range of 9% to 11%, and “about 1” means from 0.9 to 1.1.

When a list is presented, unless stated otherwise, it is to be understood that each individual element of that list and every combination of that list is to be interpreted as a separate embodiment. For example, a list of embodiments presented as “A, B, or C” is to be interpreted as including the embodiments, “A,” “B,” “C,” “A or B,” “A or C,” “B or C,” or “A, B, or C.”

It is to be appreciated that certain features of the invention which are, for clarity, described herein in the context of separate embodiments, may also be provided in combination in a single embodiment. That is, unless obviously incompatible or excluded, each individual embodiment is deemed to be combinable with any other embodiment s) and such a combination is considered to be another embodiment. Conversely, various features of the invention that are, for brevity, described in the context of a single embodiment, may also be provided separately or in any sub-combination. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Finally, while an embodiment may be described as part of a series of steps or part of a more general structure, each said step may also be considered an independent embodiment in itself.

While the present disclosure has illustrated by description several embodiments and while the illustrative embodiments have been described in considerable detail, it is not the intention of the applicant to restrict or in any way limit the scope of the appended claims to such detail. Additional advantages and modifications may readily appear to those skilled in the art. Furthermore, features from separate lists can be combined; and features from the examples can be generalized to the whole disclosure.

What is claimed is:

1. A segmented sample handling tray comprising:
a plurality of sample handling segments, each sample handling segment includes a plurality of sample positions for sample containers;
wherein the segmented sample handling tray transitions between a compact two-dimensional array configuration and an extended linear configuration by at least partially separating the plurality of sample handling segments.

2. The segmented sample handling tray of claim 1, wherein the extended linear configuration includes the plurality of the sample handling segments being substantially end-to-end.

3. The segmented sample handling tray of claim 1, wherein the compact two-dimensional array configuration includes the plurality of the sample handling segments being substantially side-by-side.

4. The segmented sample handling tray of claim 1, wherein a lateral side of each of the plurality of sample handling segments is at least partially open such that the sample containers are visible within the sample handling segments.

5. The segmented sample handling tray of claim 1, wherein the plurality of sample handling segments are coupled together using integral hinges.

6. The segmented sample handling tray of claim 5, wherein the integral hinges are attached to the sample handling segments at an edge between an end and a lateral side of the sample handling segments.

7. The segmented sample handling tray of claim 5, wherein the integral hinges are attached to the sample handling segments at an end of the sample handling segment.

8. The segmented sample handling tray of claim 1, wherein the plurality of sample handling segments are coupled together using mechanical hinges.

9. A sample handling system for use with a segmented sample handling tray, the segmented sample handling tray including a plurality of sample handling segments, comprising:
a loading area for holding a segmented sample handling tray in a compact two-dimensional configuration;
a conveyor for transporting the segmented sample handling tray in an extended linear configuration;
a sample container read zone configured to identify the sample containers within the segmented sample handling tray; and
a needle access zone for sampling the contents of the sample containers.

10. The sample handling system of claim 9, wherein the extended linear configuration includes the plurality of the sample handling segments being substantially end-to-end.

11. The sample handling system of claim 9, wherein the compact two-dimensional array configuration includes the plurality of the sample handling segments being substantially side-by-side.

12. The sample handling system of claim 9, wherein the sample container read zone includes a camera to read a label on the side of a sample container within one of the plurality of sample handling segments, a lateral side of each of the plurality of sample handling segments being at least partially open so the label is visible to the camera.

13. The sample handling system of claim 9, wherein the sample container read zone includes RFID reader to read an RFID tag on a sample container within one of the plurality of sample handling segments.

14. The sample handling system of claim 9, further comprising a needle for accessing the contents of the sample container and providing the contents to an analytical system.

15. The sample handling system of claim 14, wherein the analytical system includes a liquid chromatography system, an ion chromatography system, a gas chromatography system, a mass spectrometry system, a genetic analysis system, a gene sequencing system, an immunoassay system, or any combination thereof.
